(19) United States
(12) Patent Application Publication
(10) Pub. No.: US 2026/0201830 A1
(43) Pub. Date: Jul. 16, 2026

(54) ENGINE SYSTEM, TURBOCHARGER ASSEMBLY, AND TURBOCHARGER HOUSING

(71) Applicant: Cummins Inc., Columbus, IN (US)

(72) Inventors: Kieran J. Richards, West Haddon (GB); Jacques L. Vincent, Rugby (GB); Edward D. Koeberlein, Columbus, IN (US); Callum Munro, Daventry (GB)

(73) Assignee: Cummins Inc., Columbus, IN (US)

(21) Appl. No.: 19/559,791

(22) Filed: Mar. 6, 2026

Related U.S. Application Data
(62) Division of application No. 18/996,350, filed on Jul. 20, 2023.

(30) Foreign Application Priority Data
Jul. 21, 2022 (GB) 2210685.0

(51) Int. Cl. F02B 39/00; F01D 25/14; F01D 25/24; F02B 37/013; F02B 37/02

(52) U.S. Cl. CPC F02B 39/005; F01D 25/145; F01D 25/243; F02B 37/013; F02B 37/02; F05D 2220/40; F05D 2260/20

(57) ABSTRACT

A turbocharger housing includes a first fluid passage and a second fluid passage. The first fluid passage includes an exhaust gas inlet, a volute, and an exhaust gas outlet. The volute extends from the exhaust gas inlet in a circumferential direction relative to a central axis of the exhaust gas outlet. The second fluid passage extends parallel to the first fluid passage between the exhaust gas inlet and the exhaust gas outlet. The second fluid passage includes an outlet opening that is offset from the exhaust gas outlet.

### CROSS-REFERENCE TO RELATED PATENT APPLICATIONS

This application is a continuation of U.S. patent application Ser. No. 18/996,350, filed Jan. 17, 2025, which is a U.S. National Stage Application filed under 35 U.S.C. § 371 of International Application No. PCT/US2023/028268, filed Jul. 20, 2023, which claims the benefit of and priority to United Kingdom Patent Application No. 2210685.0, filed Jul. 21, 2022, the entire contents of which are incorporated herein by reference.

### TECHNICAL FIELD

The present disclosure relates generally to water-cooled exhaust systems for turbocharged internal combustion engine systems.

### BACKGROUND

Many gaseous fueled engine systems use turbochargers to improve the efficiency (e.g., fuel consumption) and power output of the system. The turbocharger recovers energy from the hot exhaust gases produced by the engine and uses this energy to compress incoming air, increasing the density of the air, to allow more power per engine cycle. The temperature of exhaust gases entering the turbocharger can exceed 750° C. in some instances.

### SUMMARY

One embodiment of the present disclosure relates to a turbocharger housing. The turbocharger housing includes a first fluid passage and a second fluid passage. The first fluid passage includes an exhaust gas inlet, a volute, and an exhaust gas outlet. The volute extends from the exhaust gas inlet in a circumferential direction relative to a central axis of the exhaust gas outlet. The second fluid passage extends parallel to the first fluid passage between the exhaust gas inlet and the exhaust gas outlet. The second fluid passage includes an outlet opening that is offset from the exhaust gas outlet.

Another embodiment of the present disclosure relates to turbocharger housing. The turbocharger housing includes an outlet flange having an exhaust gas outlet, a fluid outlet, and a plurality of fastener openings. The fluid outlet is radially offset from both the exhaust gas outlet and the plurality of fastener openings.

It should be appreciated that all combinations of the foregoing concepts and additional concepts discussed in greater detail below are contemplated as being part of the subject matter disclosed herein. In particular, all combinations of claimed subject matter appended at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic diagram of a cooling system layout that includes a single stage turbocharger configuration, according to an embodiment.

FIG. 2 is a perspective view of an engine system that implements the cooling system layout of FIG. 1.

FIG. 3 is a partial perspective view of the engine system of FIG. 2.

FIG. 4 is a partial perspective view of a turbocharger assembly that can be used with the engine system of FIG. 2.

FIG. 5 is a side view of the turbocharger assembly of FIG. 4.

FIG. 6 is a schematic diagram of a cooling system layout that includes a single stage turbocharger configuration, according to another embodiment.

FIG. 7 is a schematic diagram of a cooling system layout that includes a dual stage turbocharger configuration, according to an embodiment.

FIG. 8 is a perspective view of an engine system that implements the cooling system layout of FIG. 1.

FIG. 9 is a front perspective view of an exhaust collector for the engine system of FIG. 8.

FIG. 10 is rear perspective view of the exhaust collector of FIG. 9.

FIG. 11 is a top partial view through a turbocharger assembly of yet another engine system, according to an embodiment.

FIG. 12 is a perspective partial view of the turbocharger assembly of FIG. 11.

FIG. 13 is another partial view of the turbocharger assembly of FIG. 11.

FIG. 14 is a top cross-sectional view through an engine system that is arranged according to the cooling system layout shown in FIG. 6.

FIG. 15 is a flow diagram of a method of assembly for an exhaust system, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to modular exhaust system for a turbocharged engine. The modular exhaust system includes cooling passageways that are integrated into the exhaust system components, which can reduce or eliminate the need for separate coolant lines to direct the flow coolant to different parts of the exhaust system. By reducing or eliminating the cooling lines, the modular exhaust system is configured to reduce or eliminate the need for shielding and/or other components to protect other parts of the vehicle and engine system (e.g., spray shields to mitigate leaks from the coolant lines and other auxiliary cooling equipment during operation, heat shielding to reduce heat transfer to components adjacent to the cooling lines, etc.).

In at least one embodiment, the modular exhaust system includes cooling passageways that extend in series along each component of the exhaust system and the connections therebetween. The passageways are configured to provide a barrier to heat transfer without any unprotected areas along the exhaust system, thereby reducing and/or eliminating the need for heat blankets, metal cladding, and/or other fire suppression equipment. In some embodiments, the modular exhaust system is configured to reduce surface temperatures across the entire exhaust system for conformance with jurisdictional ordinances and regulations (e.g., safety of life at sea (SOLAS) surface temperature thresholds for marine applications). For example, the modular exhaust system is structured to reduce surface temperatures to at or below approximately 220° C. in various embodiments.

Additionally, due to the integration of the cooling passageways into the exhaust system components, the modular exhaust system is reconfigurable into either a single stage configuration (e.g., having a single turbocharger), or a multi-stage configuration (e.g., having multiple turbochargers) without having to reroute or rearrange external pipes and auxiliary components. As such, the modular exhaust system design is configured to reduce part proliferation across different engine variants.

The various concepts introduced above and discussed in greater detail below may be implemented in any of numerous ways, as the described concepts are not limited to any particular manner of implementation. Examples of specific implementations and applications are provided primarily for illustrative purposes.

Various numerical values herein are provided for reference purposes only. Unless otherwise indicated, all numbers expressing quantities of properties, parameters, conditions, and so forth, used in the specification and claims are to be understood as being modified in all instances by the term “approximately.” Accordingly, unless indicated to the contrary, the numerical parameters set forth in the following specification and attached claims are approximations. Any numerical parameter should at least be construed in light of the number reported significant digits and by applying ordinary rounding techniques. The term “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

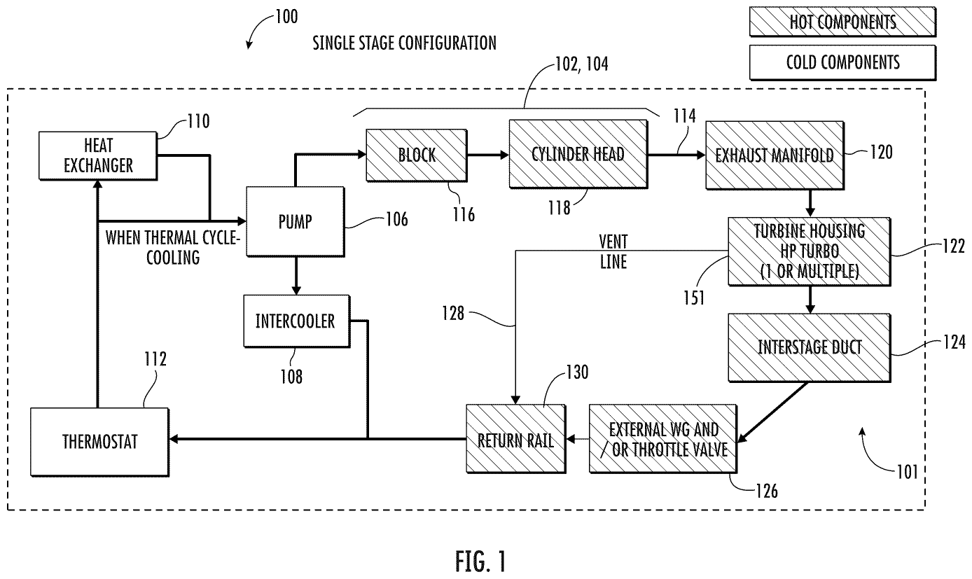

FIG. 1 shows a schematic diagram of a cooling system 100 for a modular exhaust system, shown as exhaust system 101, according to at least one embodiment. The exhaust system 101 integrates portions of the cooling system 100 into various components of the exhaust system 101. The cooling system is configured as a liquid cooling system in which a flow of a liquid coolant is used to cool the various system components. The liquid coolant is, for example, water or a mixture of water and antifreeze, although other liquid coolants are usable.

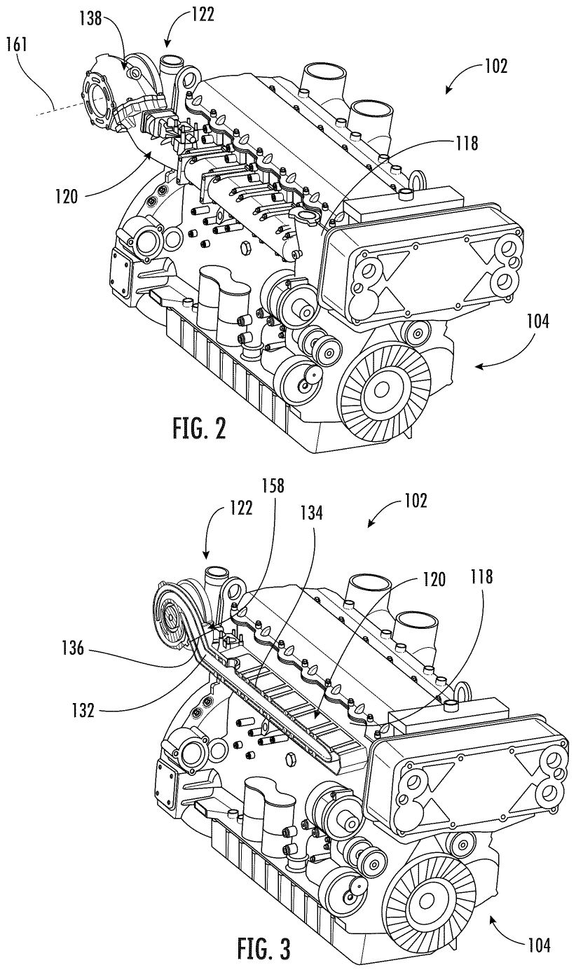

As shown in FIG. 2, in at least one embodiment, the exhaust system 101 forms part of an internal combustion engine system 102 that includes an engine 104 (see FIG. 2). The engine 104 is configured to be a diesel engine, a gasoline engine, a natural gas engine, a dual fuel engine, a biodiesel engine, an E85 engine, a flex fuel engine, a gas turbine, or another type of internal combustion engine or driver. The engine 104 can be a Vee block configuration, an in-line engine, or another engine configuration. In various embodiments, the engine 104 is configured to be a high horse power (HHP) engine, such as, for example, an engine capable of providing power in the range of 500 hp to 4,500 hp or more. The internal combustion engine system 102 is utilizable to power an electric power generator (e.g., genset, etc.) used to produce electricity (e.g., power), an alternator, or the like. In one embodiment, the engine 104 is coupled to the generator by, for example, a driveshaft (not shown). In other embodiments, the internal combustion engine system 102 is utilizable in a marine application (e.g., to power a boat), a mining application (e.g., to power a haul truck and/or excavator), or a rail application (e.g., to power a locomotive). In other embodiments, the internal combustion engine system 102 is utilizable to power another type of vehicle (e.g., an on-road or off-road vehicle). In yet other embodiments, the internal combustion engine system 102 is utilizable in an industrial application to drive a pump, hydraulic system, or another type of system.

As shown in FIG. 1, the cooling system 100 includes a fluid driver 106, an intercooler 108, a heat exchanger 110, a thermostat 112, and a plurality of fluid passageways 114 (e.g., flow conduits, channels, etc.) through various portions of the exhaust system 101. In other embodiments, the cooling system 100 may include additional, fewer, and/or different components.

The fluid driver 106 is structured to pump a fluid (e.g., a liquid coolant) through the cooling system 100. The fluid driver 106 is configured as a water pump which is arranged to be driven by a belt from the engine 104, a motor, or another suitable actuator.

As shown in FIG. 1, the fluid driver 106 pumps the fluid through an engine block 116 of the engine 104 and a cylinder head 118 of the engine 104 before entering the exhaust system 101. The fluid then moves through the fluid passageways 114 to cool the exhaust system 101 (e.g., raising the temperature of the fluid). At the same time, the fluid driver 106 is structured to pump the fluid through the intercooler 108. The intercooler 108 is configured to be plumbed in a parallel flow arrangement with the exhaust system 101.

As shown in FIG. 1, fluid (e.g., at elevated temperature) returning from the exhaust system 101 and intercooler 108 is directed through the heat exchanger 110. The heat exchanger 110 is configurable as a radiator structured to reject heat to an environment surrounding the internal combustion engine system 102. In the embodiment of FIG. 1, the fluid passes through a thermostat 112 before entering the heat exchanger 110. The thermostat 112 is structured to automatically bypass the heat exchanger 110 during engine startup (e.g., when the fluid is below a temperature threshold). The automatic bypassing is configured to reduce the time required for the engine 104 and exhaust system 101 to reach a steady state operating temperature (e.g., an average operating temperature of the coolant when the engine 104 is running).

In the example embodiment of FIG. 1, the exhaust system 101 is arranged in a single stage configuration that provides a single stage of compression to air entering the engine 104. The exhaust system 101 includes an exhaust manifold 120, a turbocharger assembly 122, an exhaust collector 124, and an external wastegate and/or throttle valve, shown as valve 126. In other embodiments, the exhaust system 101 may include additional, fewer, and/or different components. For example, in at least one embodiment, the exhaust system 101 can include multiple turbocharger assemblies 122 arranged in a parallel flow configuration to increase the overall flow rate into the engine 104.

As shown in FIG. 1, the exhaust system 101 is arranged so that the fluid passes in through each of the exhaust manifold 120, the turbocharger assembly 122, the exhaust collector 124, and the valve 126 in series. The fluid flows through the fluid passageways 114 that extend along a flow path of exhaust gas through the exhaust system 101.

In at least one embodiment, the cooling system 100 is integrated with internal de-aeration (e.g., venting). The internal de-aeration is configured to reduce trapped air in the cooling system 100. As shown in FIG. 1, the cooling system 100 includes a vent line 128 extending between and fluidly coupled to (i) the fluid passageway 114 through the turbocharger assembly 122, and (ii) a return rail 130 of the cooling system 100. In at least one embodiment, the return rail 130 is a tank or fluid reservoir disposed at an upper end (e.g., top) of the heat exchanger 110. In other embodiments, the return rail 130 is located at another position along the engine system 101 (e.g., an expansion tank disposed above the engine, etc.).

FIG. 2 shows a perspective view of the internal combustion engine system 102 that incorporates the cooling system 100 of FIG. 1. As shown, the exhaust manifold 120 is disposed along an upper end of the engine 104 and is coupled to the cylinder head 118. The exhaust manifold 120 extends along the cylinder head 118 between a front end and a rear end of the engine 104. The turbocharger assembly 122 is coupled to the exhaust manifold 120 at the rear end of the engine 104, and protrudes beyond the rear end. In other embodiments, the turbocharger assembly 122 is positioned differently.

As shown in FIG. 2, an inlet to the turbocharger assembly 122 is fluidly coupled to an outlet of the exhaust manifold 120. An outlet of the turbocharger assembly 122 is fluidly coupled to an inlet of the exhaust collector 124 (see FIG. 1). The turbocharger assembly 122 is structured so that the fluid (e.g., liquid coolant) and the exhaust gas both enter the turbocharger assembly 122 along a same axis direction (e.g., a first axis direction). In FIG. 2, for example, the first axis direction is a tangential direction with respect to an outer perimeter of a turbocharger housing 138 of the turbocharger assembly 122. The fluid and exhaust gas are also discharged from the turbocharger assembly 122 along a same axis direction (e.g., a second axis direction). In FIG. 2, for example, the second axis direction is an axial direction with respect to a rotational axis 161 of a turbine of the turbocharger assembly 122.

FIG. 3 shows a partial perspective view of the exhaust manifold 120 and the turbocharger assembly 122. The exhaust manifold 120 is structured to receive exhaust gas from the cylinder head 118 and direct the exhaust gas to the turbocharger assembly 122. The exhaust manifold 120 can be structured to direct a flow of fluid therethrough parallel to a flow of exhaust gas along an entire length of the exhaust manifold. As shown in FIG. 3, the exhaust manifold 120 includes an exhaust conduit 132 and a manifold jacket 134. The exhaust conduit 132 (e.g., channel, runner, etc.) extends between and fluidly couples the cylinder head 118 to the inlet of the turbocharger assembly 122. The manifold jacket 134 at least partially surrounds the exhaust conduit 132 and is fluidly coupled to a fluid inlet 136 of the turbocharger assembly 122.

In the embodiment of FIG. 3, the manifold jacket 134 covers the exhaust conduit 132 on at least four sides. The manifold jacket 134 extends along an entire length of the exhaust conduit 132. The manifold jacket 134 protrudes beyond the exhaust conduit 132, proximate the front end of the engine 104, so that no portion of the exhaust conduit 132 is exposed to the environment surrounding the internal combustion engine system 102. In at least one embodiment, the manifold jacket 134 is integrally formed with the exhaust conduit 132 and is bolted or otherwise coupled to the cylinder head 118 and/or engine 104 as a single unitary structure. In other embodiments, the manifold jacket 134 is a separate component from the exhaust conduit 132 that is bolted or otherwise coupled to the cylinder head 118 and/or engine 104 separately from the manifold jacket 134.

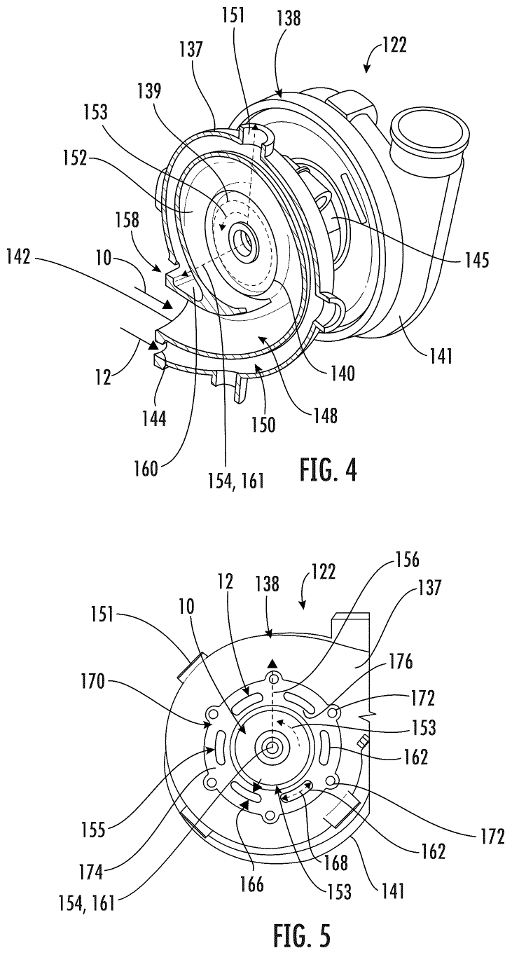

FIGS. 4 and 5 show a cross-sectional view and a side view, respectively, of the turbocharger assembly 122 (e.g., turbocharger, etc.). The turbocharger assembly 122 is structured to convert energy from an exhaust gas 10 flowing through the turbocharger assembly 122 to shaft power to drive a compressor. The turbocharger assembly 122 includes a turbocharger housing, shown as housing 138. The turbocharger assembly 122 further includes a turbine 139 rotatably coupled to the housing 138 via a shaft, and a compressor impeller disposed on an opposite end of the shaft as the turbine 139.

The housing 138 is structured to direct the flow of the exhaust gas 10 and a flow of a fluid 12 through the turbocharger assembly 122. The housing 138 is configured as a multi-piece assembly that includes a turbine housing 137 (e.g., a turbine casing, etc.), a compressor housing 141 (e.g., a compressor casing, etc.), and a center housing 145 extending between and coupled to the turbine housing 137 and the compressor housing 141. In some embodiments, the turbine housing 137 is cast or otherwise formed from a single piece of material. In other embodiments, the turbine housing 137 is formed from multiple pieces of material that are welded or otherwise coupled together.

As shown in FIGS. 4 and 5, the housing 138 (e.g., turbine housing 137) includes an exhaust gas inlet 142, a fluid inlet 144, a turbine opening 140, a first fluid passage 148, a second fluid passage 150, a coolant port 151, an exhaust gas outlet 153, and a fluid outlet 155.

As shown in FIG. 4, the turbine opening 140 is disposed at a central position along the housing 138 and is sized to receive the turbine 139 therein. The first fluid passage 148 is structured to direct the flow of exhaust gas 10 through the housing 138 (e.g., across the turbine 139). The first fluid passage 148 includes the exhaust gas inlet 142, a volute 152 (e.g., a collector, etc.), and the exhaust gas outlet 153. As shown in FIG. 4, the volute 152 extends from the exhaust gas inlet 142 in a circumferential direction 143 relative to a central axis 154 of the exhaust gas outlet 153 and turbine opening 140.

The second fluid passage 150 is structured to direct the flow of the fluid 12 (e.g., liquid coolant) through the housing 138 to cool the turbocharger assembly 122 during operation. The second fluid passage 150 includes the fluid inlet 144. The fluid inlet 144 is arranged coaxially with the exhaust gas inlet 142. As shown in FIG. 4, the second fluid passage 150 surrounds (e.g., circumscribes) the first fluid passage 148. The second fluid passage 150 extends in the circumferential direction 143 along a length of the volute 152.

The housing 138 further includes a coolant port 151 that is fluidly coupled to the second fluid passage 150 and that extends radially away from the second fluid passage 150, in a radial direction 156 through the housing 138 (e.g., through an outer wall and/or sidewall of the housing 138). The coolant port 151 can include a boss and/or protrusion disposed along an outer wall of the housing 138. As shown in FIG. 1, the vent line 128 is coupled to and extends between the coolant port 151 and the return rail 130.

In the embodiment of FIG. 4, the coolant port 151 is one of a plurality of coolant ports 151 that are fluidly coupled to the second fluid passage 150 between the fluid inlet 144 and the fluid outlet 155 (shown in FIG. 5). The plurality of coolant ports 151 are configured to be spaced at approximately equal intervals along the length of the second fluid passage 150. In the embodiment of FIG. 4, the plurality of coolant ports 151 are arranged along the circumferential direction 143 at approximately 90° intervals along a length of the second fluid passage 150. Beneficially, using multiple coolant ports 151 provides flexibility when installing the turbocharger assembly 122. For example, using multiple coolant ports 151 allows different clocking of the turbocharger assembly 122 with respect to the engine. Further, using multiple coolant ports 151 facilitates de-aeration of the second fluid passage 150 (e.g., as one of the coolant ports 151 will be positioned along an upper side of the housing 138 and allow pockets of air to vent from the housing 138).

As shown in FIG. 4, the exhaust manifold 120 is fluidly coupled to the housing 138 (e.g., to the exhaust gas inlet 142). The housing 138 can further include an inlet flange 158 that is structured to engage with and couple to an outlet of the exhaust manifold 120 (see FIG. 3). The inlet flange 158 circumscribes (e.g., surrounds) the exhaust gas inlet 142 and the fluid inlet 136. In the embodiment of FIG. 4, the inlet flange 158 includes bolt openings to facilitate mounting of the turbocharger assembly 122 to the exhaust manifold 120. The fluid inlet 136 surrounds (e.g., circumscribes) the exhaust gas inlet 142 and is arranged coaxially with the exhaust gas inlet 142.

As shown in FIG. 5, the second fluid passage 150 includes a fluid outlet 155 that extends in an axial direction 160 through the housing 138, parallel to a rotational axis 161 of the turbine 139 (as shown in FIG. 4). In some embodiments, the second fluid passage 150 includes an outlet opening 162 of the fluid outlet 155 that is radially offset from the turbine opening 140 and the exhaust gas outlet 153.

In at least one embodiment, the second fluid passage 150 extends parallel to the first fluid passage 148 between the exhaust gas inlet 142 and the exhaust gas outlet 153. The second fluid passage 150 may form a parallel curve with the first fluid passage 148 that both extend in a circumferential direction relative to the rotational axis 161 along at least a portion of their length. In some embodiments, a central axis of the first fluid passage 148 may form a first curve (e.g., extending along a flow direction through the first fluid passage 148) and a central axis of the second fluid passage 150 may form a second curve that is radially offset from the first curve by a fixed distance along substantially an entire length of the first curve. In such an embodiment, the fluid 12 and the exhaust gas 10 may flow substantially parallel to one another along curves around the rotational axis 161 between the inlet flange 158 and the outlet flange 155 and/or may be concentric flows through the housing 137.

The second fluid passage 150 is structured to direct the flow of the fluid 12 in the axial direction 160 parallel to the flow of the exhaust gas 10 discharged from (e.g., leaving) the turbine opening 140. In particular, the fluid outlet 155 is structured to direct the fluid 12 in a direction that is parallel to the flow of the exhaust gas 10 through the exhaust gas outlet 153.

As shown in FIG. 5, the fluid outlet 155 is arranged coaxially with the exhaust gas outlet 153 so that both the fluid outlet 155 and the exhaust gas outlet 153 share a common axis (e.g., the rotational axis 161 of the turbine 139 as shown in FIG. 4). However, it should be appreciated that a location of a central axis of the fluid outlet 155 can be different from a central axis of the exhaust gas outlet 153 (e.g., the rotational axis 161) in other embodiments. For example, in some embodiments, the central axis of the fluid outlet 155 is disposed to be radially offset from the central axis of the exhaust gas outlet 153, depending on the space constraints and arrangement of the exhaust system 101.

In the embodiment of FIG. 5, the fluid outlet 155 (e.g., the outlet opening(s) 162 forming the fluid outlet 155) extends axially through a sidewall 164 of the housing 138 relative to the rotational axis 161 of the turbine 139. The exhaust gas outlet 153 and the fluid outlet 155 are structured to direct the fluid 12 and the exhaust gas 10, respectively, along the axial direction 160 relative to the rotational axis 161 of the turbine 139.

The fluid outlet 155 includes an outlet opening 162 that is radially offset from the exhaust gas outlet 153. In the embodiment of FIG. 5, the outlet opening 162 is one of a plurality of outlet openings 162 that are arranged coaxially with the turbine opening 140 and the exhaust gas outlet 153 (e.g., such that a circular reference line extending through each of the outlet openings 162 is arranged coaxially with the turbine opening 140 and the exhaust gas outlet 153).

As shown in FIG. 5, the outlet openings 162 at least partially surround the turbine opening 140 and the exhaust gas outlet 153. In some embodiments, each outlet opening 162 is elongated along the circumferential direction 143. In the embodiment of FIG. 5, the outlet openings 162 are reniform (e.g., kidney shaped, bean shaped, lozenge shaped, etc.) and have a width 166 along the radial direction 156 that is smaller than a length 168 along the circumferential direction 143.

In at least one embodiment, the outlet openings 162 define/form an elongated oval shape having an inward curve on one side and/or an outward curve on an opposing side at an intermediate/central position along the opening (e.g., at a central position along the length 168 of the outlet opening 162, etc.). An inner and outer radial edge of the outlet openings 162 may have an approximately constant radius forming a portion of an annulus around the exhaust gas outlet 153. The outlet openings 162 can have rounded corners, which can reduce stress concentrations in the housing 138.

As shown in FIG. 5, the housing 138 further includes an outlet flange 170 that is structured to couple the turbocharger assembly 122 (e.g., the housing 138) to the exhaust collector 124. As shown in FIGS. 4 and 5, the outlet flange 170 is disposed on an opposite side of the turbine housing 137 as the compressor housing 141. The outlet flange 170 circumscribes (e.g., surrounds) the exhaust gas outlet 153 and the fluid outlet 155 and is arranged coaxially with the exhaust gas outlet 153 and the fluid outlet 155.

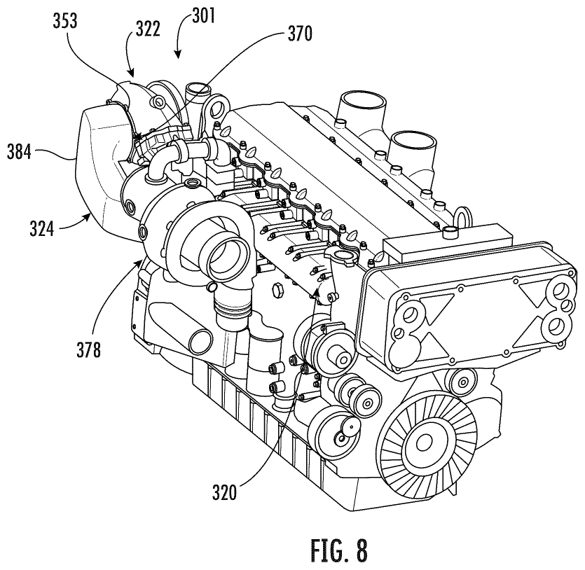

As shown in FIG. 5, the outlet flange 170 includes a plurality of fastener openings 172 (e.g., bolt openings) that are structured to facilitate mounting of the turbocharger assembly 122 to the exhaust collector 124 (an embodiment of which will be described in further detail with reference to FIG. 8). The fastener openings 172 may be arranged around the outlet flange 170 and/or circumferentially arranged around the outlet flange 170. In some embodiments, the fastener openings 172 are arranged in a circular pattern to at least partially surround the turbine opening 140 and the exhaust gas outlet 153.

In the embodiment of FIG. 5, the fluid outlet 155 is radially offset from both the exhaust gas outlet 153 and the plurality of fastener openings 172. The plurality of outlet openings 162 can be disposed radially between the plurality of fastener openings 172 and the turbine opening 140 (the exhaust gas outlet 153). As shown, the plurality of outlet openings 162 are spaced radially apart from the plurality of fastener openings 172 by a first distance to form a first sealing surface 174, and the plurality of outlet openings 162 are spaced radially apart from the exhaust gas outlet 153 by a second distance to form a second sealing surface 176 that is radially offset from the first sealing surface 174.

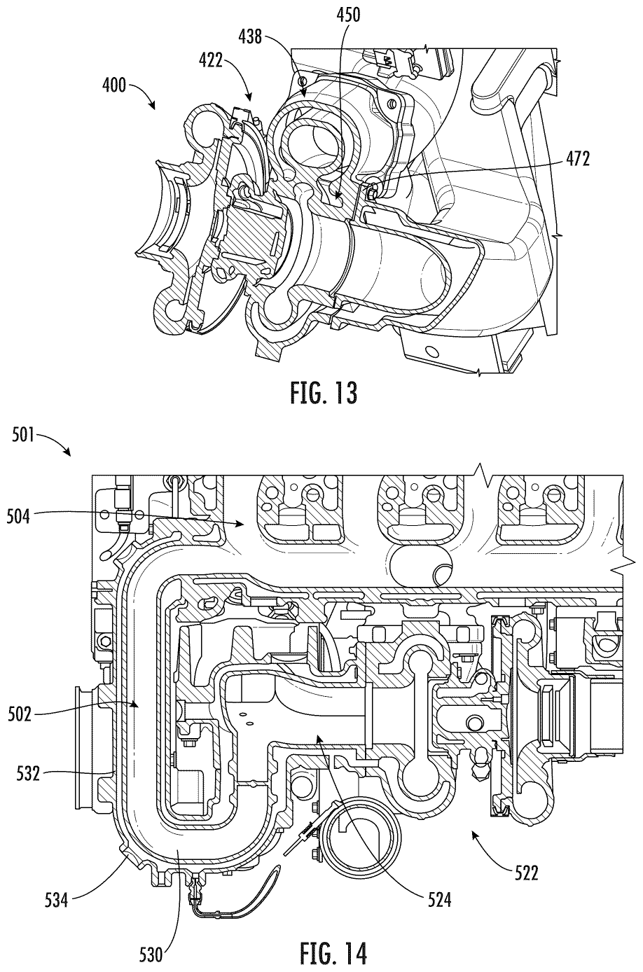

Positioning the fluid outlet between the fastener openings 172 and the exhaust gas outlet 153 can, beneficially, reduce resistance to flow across the system by increasing the average cross-sectional area for fluid flow at a given flange size. For example, positioning the fluid outlet radially inward from the fastener openings 172 eliminates the need to reduce the cross-sectional area of the second fluid passage 150 in the vicinity of the fastener openings 172. FIG. 13 shows a partial cross-sectional view through a turbocharger housing, shown as housing 438, that is the same as or similar to the housing 138 of FIG. 5. As shown, at least a portion of the second fluid passage 450 through the housing 438 is circumferentially aligned with, and extends parallel to, at least one of the plurality of fastener openings 472 (e.g., the second fluid passage 450, where it engages the outlet flange, extends along an entire circumference of the housing 438). The at least one fastener opening 472 comprises a threaded interface that extends into the housing 438 and does not require a separate nut to secure the fastener to the housing 438.

Among other benefits, using a reniform shape and/or elongated oval shape for the outlet openings 162 reduces flow restriction across the outlet flange 170 (as compared to circular-shaped fluid openings) and allows for a reduction in the diameter of the bolt pattern for the outlet flange 170. The shape of the outlet openings 162 also increases a surface area available for cooling (e.g., the surface area of the outlet flange 170 exposed to the flow of coolant).

In the embodiment of FIG. 5, the plurality of outlet openings 162 are offset from the plurality of fastener openings 172 along the circumferential direction 143. Thus, in FIG. 5, a clocking of the plurality of outlet openings 162 differs from a clocking of the plurality of fastener openings 172. In the embodiment of FIG. 5, each outlet opening 162 is disposed circumferentially between (e.g., halfway between) a corresponding pair of the bolt openings, which beneficially, reduces thermal stresses in the outlet flange 170. In some embodiments, the number of outlet openings 162 is the same as the number of fastener openings 172 (e.g., six, etc.). It should be appreciated that the arrangement and shape of the outlet openings 162 may be different in other embodiments.

Beneficially, the housing 138 (e.g., turbine housing 137) is structured so that the fluid can flow through the complete exhaust system 101 in series, without any gaps along the flow path of the exhaust system 101. The housing 138 is thus structured to provide a barrier to heat transfer between the exhaust gas 10 and the environment surrounding the internal combustion engine system 102 (see FIG. 1).

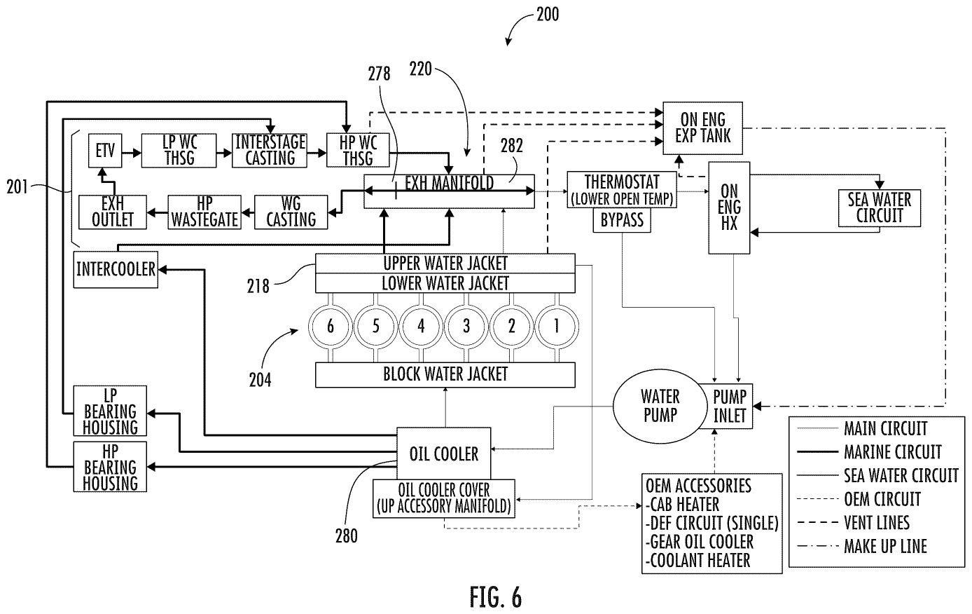

The number and arrangement of components described with reference to FIGS. 1-5 are provided for illustrative purposes only. It should be appreciated that various alternatives are possible without departing from the inventive principles disclosed herein. For example, FIG. 6 shows another example embodiment of a cooling system 200 for a modular exhaust system, shown as exhaust system 201. The cooling system 200 includes an exhaust manifold 220 that is divided into multiple portions including a first manifold portion 278 and a second manifold portion 282 that is coupled to the first manifold portion 278.

As shown in FIG. 6, the cooling system 200 directs the flow of a fluid 12 from the cylinder head 218 of the engine 204 into the first manifold portion 278 before passing the fluid 12 through the exhaust system 201. Portions of the exhaust system 201 can also receive fluid 12 from an engine oil cooler 280 (e.g., via low and high pressure bearing housings). The flow of fluid 12 leaving (being discharged from) the exhaust system 201 then returns through a second manifold portion 282 of the exhaust manifold 220 and flows through the second manifold portion 282 away from the first manifold portion 278 (e.g., in a second flow direction that is opposite to a first flow direction through the first manifold portion 278).

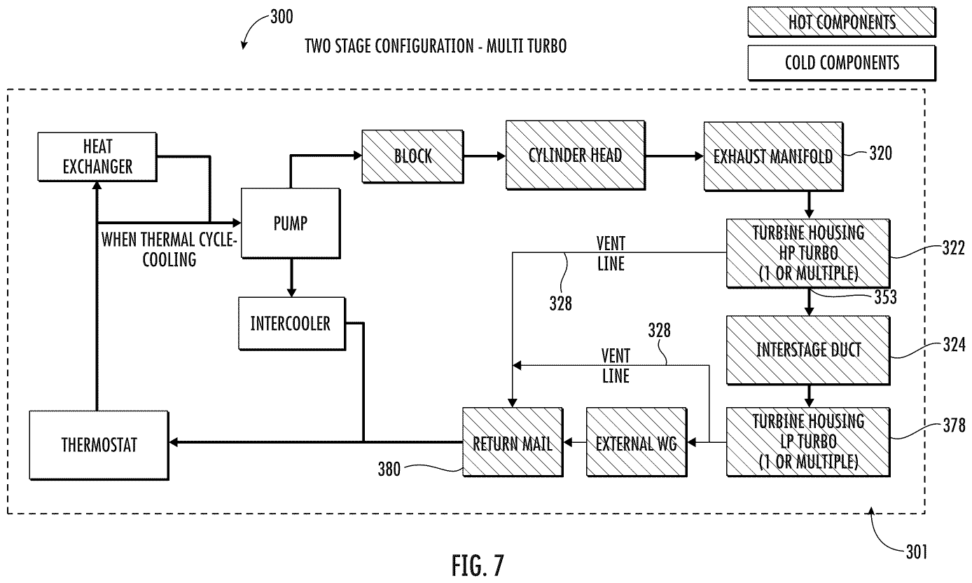

FIG. 7 shows an example embodiment of a cooling system 300 for a modular exhaust system that includes two turbocharger assemblies arranged in a series flow configuration (e.g., a two stage configuration providing two stages of compression, etc.). The cooling system 300 is arranged in a similar manner to the cooling system 100 described with reference to FIG. 1.

As shown in FIG. 7, the exhaust system 301 includes a first turbocharger assembly 322 and a second turbocharger assembly 378 that is coupled to the first turbocharger assembly 322 and is disposed downstream from the first turbocharger assembly 322. In some embodiments, the first turbocharger assembly 322 (or second turbocharger assembly 378) is one of a plurality of turbocharger assemblies that are arranged in a parallel flow configuration to increase the flow rate to the internal combustion engine system. In yet other embodiments, the exhaust system includes three or more stages (e.g., a three stage “sequential” layout, a four stage layout, etc.) to increase the overall pressure of air entering the engine, where each stage can include one or more turbocharger assemblies arranged in a parallel flow configuration. As shown in FIG. 7, the turbocharger assemblies at each stage are configured to be fluidly coupled to a common return rail, shown as return rail 380 by vent lines 328 that are coupled to and extend between a coolant port of the turbocharger housing and the return rail 380.

The cooling system 300 can be integrated with the exhaust manifold 320, the first turbocharger assembly 322 (e.g., a first turbocharger housing of the first turbocharger assembly 322), and the second turbocharger assembly 378 (e.g., a second turbocharger housing of the second turbocharger assembly) to allow fluid of the cooling system to cool the exhaust manifold 320, the first turbocharger assembly 322, and the second turbocharger assembly 378 without any intervening fluid conduits (e.g., without any dedicated fluid conduits for the fluid that direct only fluid to different components of the exhaust system, etc.). In some embodiments, the exhaust manifold 320 is fluidly coupled to the first turbocharger assembly 322 (e.g., at an inlet flange of the first turbocharger assembly 322). The second turbocharger assembly 378 is coupled to an exhaust collector 324 (e.g., interstage duct, interstage section, exhaust outlet conduit, etc.) that is engaged with and extends between the first turbocharger assembly 322 and the second turbocharger assembly 378.

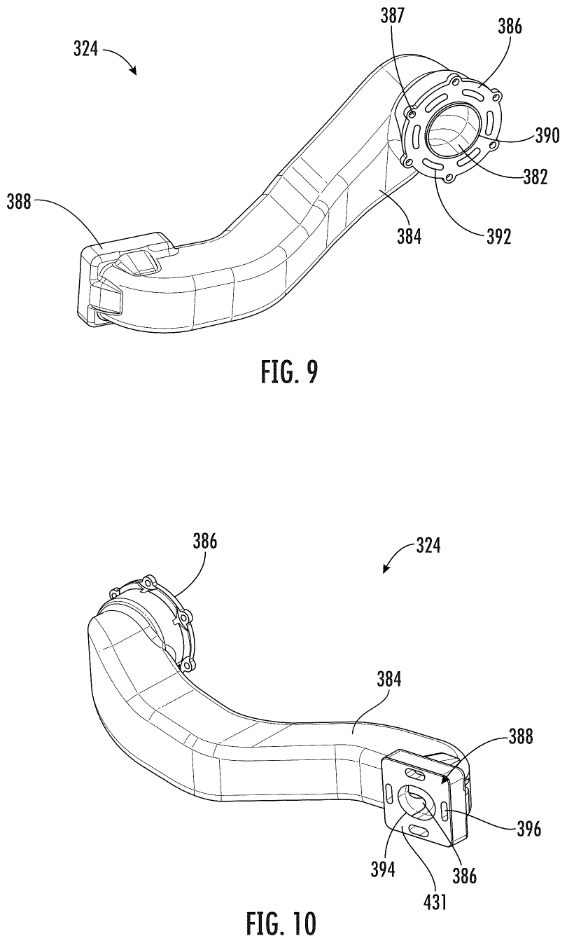

FIG. 8 shows a perspective view of the exhaust system 301 of FIG. 7. The second turbocharger assembly 378 (e.g., a second turbocharger housing of the first turbocharger assembly 378) is fluidly coupled to the first turbocharger assembly 322 (e.g., a first turbocharger housing of the first turbocharger assembly 378) and has the same flow path therethrough as the first turbocharger assembly 322. The exhaust collector 324 is structured to direct exhaust gas and fluid between the first turbocharger assembly 322 and the second turbocharger assembly 378 in a series flow arrangement between the first turbocharger assembly 322 and the second turbocharger assembly 378. The second turbocharger assembly 378 is fluidly coupled to the exhaust collector 324 and is structured to receive fluid and exhaust gas from the exhaust collector 324. The exhaust collector 324 is coupled to an outlet flange 370 of the first turbocharger assembly 322 at a first end of the exhaust collector 324 (e.g., via second gasket 429 as shown in FIG. 12). The exhaust collector 324 is coupled to an inlet flange of the second turbocharger assembly 378 at a second end of the exhaust collector 324 that is opposite from the first end (e.g., via third gasket 431 as shown in FIG. 10).

FIGS. 9 and 10 show perspective views of the exhaust collector 324 of FIG. 8. In some embodiments, the exhaust collector 324 includes a collector exhaust passage 382 and a cooling jacket 384 that at least partially surrounds (e.g., fully surrounds, circumscribes, etc.) the collector exhaust passage 382 and extends parallel to the collector exhaust passage 382 along an entire length of the collector exhaust passage 382. In some embodiments, the cooling jacket 384 forms part of the cooling system 300. In the embodiment of FIG. 8, the collector exhaust passage 382 is fluidly coupled to the exhaust gas outlet 353 of the first turbocharger assembly 322. The cooling jacket 384 is fluidly coupled to the fluid outlet of the first turbocharger assembly 322.

As shown in FIGS. 9 and 10, the exhaust collector 324 includes a collector inlet flange 386 and a collector outlet flange 388 disposed on an opposite end of the exhaust collector 324 as the collector inlet flange 386.

The collector inlet flange 386 is configured to engage with the outlet flange 370 of the first turbocharger assembly 322 (see FIG. 8). In some embodiments, the collector inlet flange 386 has a similar arrangement as the outlet flange 388. For example, in the embodiment of FIG. 9, the collector inlet flange 386 defines a collector exhaust gas inlet 390 disposed centrally along the collector inlet flange 386. The collector inlet flange 386 also includes a plurality of collector fastener openings 387 spaced radially apart from the collector exhaust gas inlet 390. The collector inlet flange 386 further includes at least one collector fluid inlet 392 disposed radially between the collector exhaust gas inlet 390 and the plurality of collector fastener openings 387.

In some embodiments, the collector inlet flange 386 includes a plurality of collector fluid inlets 392 that circumferentially surround (e.g., arranged to at least partially circumscribe, etc.) the collector exhaust gas inlet 390. At least one of the collector fluid inlets 392 can have a shape that corresponds with the shape of the outlet openings on the outlet flange 370 of the first turbocharger assembly 322 (see FIG. 8). In the embodiment of FIG. 9, the collector fluid inlets 392 are each in a reniform shape.

As shown in FIG. 10, the collector outlet flange 388 includes a similar arrangement of openings as the collector inlet flange 386. For example, the collector outlet flange 388 may have a collector exhaust gas outlet 394 that is disposed centrally along the collector outlet flange 388 and at least one collector fluid outlet 396 that is spaced radially apart from the collector exhaust gas outlet 394. In the embodiment of FIG. 10, the collector outlet flange 388 includes a plurality of collector fluid outlets 396 disposed at 90 degree intervals around the collector exhaust gas outlet 394.

In some embodiments, both the collector exhaust gas outlet 394 and the collector fluid outlet 396 each form an elongated oval shape (as shown in FIG. 10). In other embodiments, the shape and/or arrangement of openings along the collector outlet flange 388 can be different.

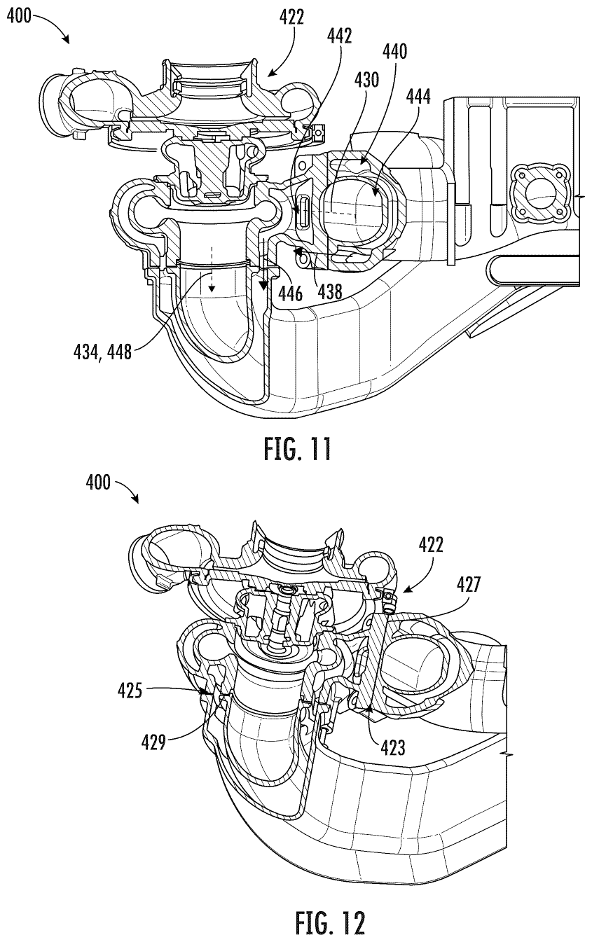

FIGS. 11-13 show various partial views of a cooling system 400, according to yet another embodiment. The cooling system 400 is shown in FIGS. 11-13 in the area of a first turbocharger assembly 422. The cooling system 400 includes a single gasketed interface (e.g., a fluid connection configured to include a single unitary gasket forming a seal between the coolant and exhaust flow path) at an inlet to the turbocharger assembly 422 (shown in FIG. 11 as first gasketed interface 423 including first gasket 427) and an outlet to the turbocharger assembly 422 (shown in FIG. 11 as second gasketed interface 425 including second gasket 429) through which both coolant and exhaust gas flows into and out of the turbocharger assembly 422, respectively.

In the embodiment of FIG. 11, coolant 440 flows into the turbocharger assembly 422 parallel to a central axis 430 of the exhaust gas inlet port 432 and flows out of the turbocharger assembly 422 parallel to a central axis 434 of the exhaust gas outlet port 436. As shown in FIG. 11, a first flow direction 439 of the coolant 440 entering the turbocharger assembly 422 is parallel to a second flow direction 442 of the exhaust gas 444 entering the turbocharger assembly 422. A third flow direction 446 of the coolant 440 exiting the turbocharger assembly 422 is parallel to a fourth flow direction 448 of the exhaust gas 444 exiting the turbocharger assembly 422.

It should be appreciated that the design of the exhaust collector can be different in various embodiments. For example, in a single stage turbocharger arrangement, the exhaust collector can be configured to route coolant and exhaust gas to exhaust piping (e.g., a muffler, etc.) instead of to a second turbocharger assembly. In some embodiments, the exhaust gas collector and/or other portions of the coolant system include coolant access ports to which flow lines can be connected to redirect coolant to other components of the system.

It should be appreciated that any component defining an exhaust gas flow path through the coolant system can be structured to include a coolant jacket and/or sleeve in a similar arrangement as the exhaust gas collector. For example, FIG. 14 shows a cross-sectional view through a cooling and modular exhaust system, shown as exhaust system 501 that is arranged in the layout of FIG. 6. As shown, the exhaust system 501 includes an exhaust manifold 504, an exhaust collector 524, and a turbocharger assembly 522 disposed between the exhaust manifold 504 and the exhaust collector 524.

As shown in FIG. 14, the exhaust system further includes at least one bypass conduit 502 extending between the exhaust manifold 504 and the exhaust collector 524. In some embodiments, the bypass conduit 502 includes a flow valve that controls the flow of exhaust gas through the bypass conduit 502. In this way, the bypass conduit 502 can form part of a wastegate for the turbocharger assembly 522 that bypasses exhaust gas across the turbocharger assembly 522 under certain operating conditions (e.g., when a pressure drop across the turbocharger assembly 522 exceeds a pressure threshold, etc.).

In the embodiment of FIG. 14, the bypass conduit 502 includes an exhaust gas conduit 530 and a coolant sleeve 532 extending parallel to the exhaust gas conduit 530 and surrounding the exhaust gas conduit 530. The bypass conduit 502 also includes at least one coolant access port 534 (e.g., boss, protrusion, etc.) extending radially away from the coolant sleeve 532 and fluidly coupled to the coolant sleeve 532. It should be appreciated that the position and number of coolant access ports 534 may be different in various embodiments.

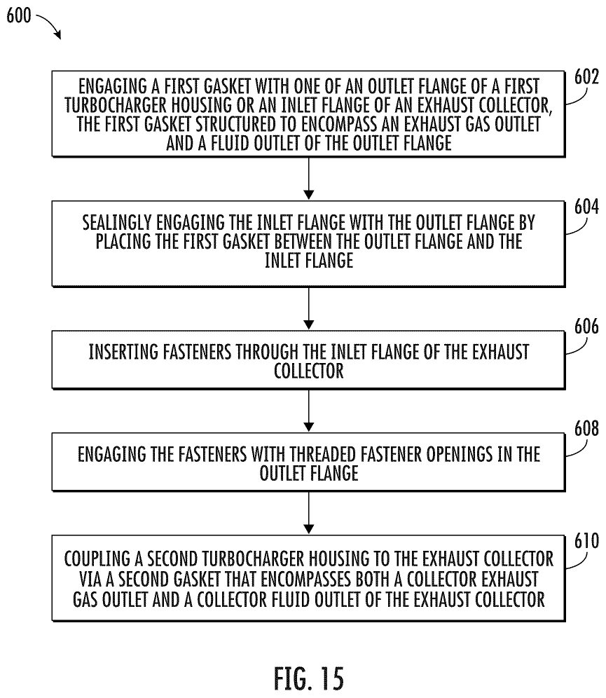

The present technology may also include, but is not limited to, the features and combinations of features recited in the following lettered paragraphs (as described with reference to FIG. 15), it being understood that the following paragraphs should not be interpreted as limiting the scope of the claims as appended hereto or mandating that all such features must necessarily be included in such claims:
A. A method of assembly of an exhaust system, the method comprising:
   engaging a first gasket with one of an outlet flange of a first turbocharger housing or an inlet flange of an exhaust collector, the first gasket structured to encompass both an exhaust gas outlet and a fluid outlet of the outlet flange and to prevent fluid bypass between exhaust gas outlet and the fluid outlet; and
   sealingly engaging the outlet flange with the inlet flange by sandwiching the first gasket between the outlet flange and the inlet flange.
B. The method of paragraph A, wherein the method further includes inserting a plurality of fasteners through the inlet flange of the exhaust collector via a plurality of collector fastener openings disposed in the inlet flange; and
   engaging the fasteners with threaded fastener openings in the outlet flange.
C. The method of paragraphs A or B, wherein the first turbocharger housing includes a fluid passage that is fluidly coupled to the fluid outlet, wherein engaging the fasteners with the threaded fastener openings includes inserting at least one fastener into a respective one of the threaded fastener opening so that a portion of the at least one fastener extends parallel to a portion of the fluid passage that is circumferentially aligned with, and extends parallel to, the respective one of the threaded fastener openings.
D. The method of any one of paragraphs A to C, further comprising coupling a second turbocharger housing to the exhaust collector via a second gasket that encompasses both a collector gas outlet and a collector fluid outlet of the exhaust collector, wherein the second turbocharger housing has the same gas and fluid flow path therethrough as the first turbocharger housing.

Other embodiments are set forth in the following claims.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A turbocharger housing, comprising:
a first fluid passage having an exhaust gas inlet, a volute, and an exhaust gas outlet, the volute extending from the exhaust gas inlet in a circumferential direction relative to a central axis of the exhaust gas outlet; and
a second fluid passage extending parallel to the first fluid passage between the exhaust gas inlet and the exhaust gas outlet, the second fluid passage having an outlet opening that is offset from the exhaust gas outlet.

2. The turbocharger housing of claim 1, wherein the second fluid passage further comprises a fluid inlet that is arranged coaxially with the exhaust gas inlet.

3. The turbocharger housing of claim 1, wherein the second fluid passage is structured to direct a flow of fluid parallel to a flow of an exhaust gas discharged from the first fluid passage through a single gasketed interface that is shared between the first fluid passage and the second fluid passage.

4. The turbocharger housing of any one of claims 1 to 3, wherein the outlet opening is one of a plurality of outlet openings that are arranged coaxially with the exhaust gas outlet.

5. The turbocharger housing of claim 4, wherein each one of the plurality of outlet openings is reniform.

6. The turbocharger housing of any one of claims 4 or 5, wherein the turbocharger housing further comprises an outlet flange structured to couple the turbocharger housing to an exhaust collector, and wherein the plurality of outlet openings are disposed on the outlet flange.

7. The turbocharger housing of claim 6, wherein the turbocharger housing further comprising a turbine housing and a compressor housing coupled to the turbine housing, and wherein the outlet flange is disposed on an opposite side of the turbine housing as the compressor housing.

8. The turbocharger housing of claim 6, wherein the outlet flange defines a plurality of bolt openings arranged to at least partially surround the exhaust gas outlet, the plurality of outlet openings disposed radially between the plurality of bolt openings and the exhaust gas outlet.

9. The turbocharger housing of claim 8, wherein the plurality of outlet openings is offset from the plurality of bolt openings along the circumferential direction.

10. The turbocharger housing of any one of claims 1 to 9, further comprising a coolant port that is fluidly coupled to the second fluid passage and extends radially away from the second fluid passage, wherein the second fluid passage surrounds the first fluid passage.

11. The turbocharger housing of claim 10, wherein the coolant port is one of a plurality of coolant ports that are fluidly coupled to the second fluid passage, wherein the plurality of coolant ports are arranged along the circumferential direction at approximately 90°intervals along a length of the second fluid passage.

12. A turbocharger housing, comprising:
an outlet flange comprising:
an exhaust gas outlet;
a fluid outlet; and
a plurality of fastener openings, the fluid outlet radially offset from both the exhaust gas outlet and the plurality of fastener openings.

13. The turbocharger assembly of claim 12, wherein the fluid outlet extends axially through a sidewall of the turbocharger housing relative to a rotational axis of the turbine.

14. The turbocharger assembly of claim 12 or 13, wherein the fluid outlet comprises a plurality of outlet openings that at least partially surround the exhaust gas outlet.

15. The turbocharger assembly of claim 14, wherein the plurality of outlet openings is disposed radially between the exhaust gas outlet and the plurality of fastener openings.

16. The turbocharger assembly of any one of claims 12 to 15, further comprising a fluid passage that is fluidly coupled to the fluid outlet, wherein a portion of the fluid passage is circumferentially aligned with, and extends parallel to, at least one of the plurality of fastener openings.

17. An exhaust system comprising the turbocharger housing of claim 1, and further comprising an exhaust collector that is coupled to the turbocharger housing, the exhaust collector including a collector exhaust passage fluidly coupled to the exhaust gas outlet, and a cooling jacket fluidly coupled to the fluid outlet and extending parallel to the collector exhaust passage along an entire length of the collector exhaust passage.

18. The exhaust system of claim 17, wherein the turbocharger housing is a first turbocharger housing, further comprising:
an exhaust manifold fluidly coupled to the first turbocharger housing; and
a second turbocharger housing coupled to the exhaust collector, wherein the fluid outlet and the cooling jacket form part of a cooling system that is integrated with the exhaust manifold, the first turbocharger housing, and the second turbocharger housing to allow fluid of the cooling system to cool the exhaust manifold, the first turbocharger housing, and the second turbocharger housing without any intervening fluid conduits.

19. The exhaust system of claim 17, wherein the turbocharger housing further comprises a coolant port extending in a radial direction through the turbocharger housing, wherein the exhaust system further comprises:
a return rail; and
a vent line coupled to and extending between the coolant port and the return rail.

20. An exhaust system comprising the turbocharger housing of claim 1, and further comprising an exhaust manifold that is fluidly coupled to the exhaust gas inlet, wherein the exhaust manifold is structured to direct a flow of fluid through therethrough parallel to a flow of exhaust gas along an entire length of the exhaust manifold.

21. An exhaust system comprising a plurality of turbocharger housings, wherein the turbocharger housing of claim 1 is a first turbocharger housing of the plurality of turbocharger housings, further comprising a second turbocharger housing that is fluidly coupled to the first turbocharger housing and has the same gas and fluid flow path therethrough as the first turbocharger housing.
